(19) United States
(12) Patent Application Publication
(10) Pub. No.: US 2019/0194968 A1
(43) Pub. Date: Jun. 27, 2019

(54) LOW-PRESSURE CHAMBER WITH TSUNAMI SHELTER FUNCTION

(71) Applicant: MIKI Corporation, Iwaki-shi, Fukushima (JP)

(72) Inventor: Yoichiro YAMANOBE, Iwaki (JP)

(73) Assignees: MIKI Corporation, Iwaki-shi, Fukushima (JP); MIKI Corporation, Iwaki-shi, Fukushima (JP)

(21) Appl. No.: 15/570,558

(22) PCT Filed: Jan. 26, 2017
(86) PCT No.: PCT/JP2017/002752

§ 371 Date: Oct. 30, 2017

(51) Int. Cl. E04H 9/14

(52) U.S. Cl. CPC E04H 9/145; H02S 20/30

(57) ABSTRACT

To provide a low-pressure chamber with tsunami shelter function which can endure severe earthquake vibrations, endure a severe muddy stream of tsunami even when a great tsunami attacks, endure a strong impact of debris, be used to wait for rescue while drifting for a long time, and be used as a low-pressure chamber for maintaining and enhancing health in a normal time. A housing includes an air supplying nozzle, an air discharging nozzle, and a housing window in a side surface. The air discharging nozzle is sequentially connected by pipes from a side near the housing to an emergency shutdown valve, a check valve, and an air discharging unit which is used to discharge the air in the housing. The air supplying nozzle is sequentially connected by pipes from a side near the housing to an emergency shutdown valve, a main air filter, a preliminary air filter, and a pressure control valve. The air discharging unit is activated to open and close the pressure control valve while continuously discharging the air in the housing in order to control a pressure in the housing to be a desired pressure curve. An air tight door includes a door window, and a window glass provided in the housing window and a window glass of the door window provided in the air tight door are provided with a window glass protection unit to protect the window glass.

### TECHNICAL FIELD

The present invention relates to a low-pressure chamber with tsunami shelter function which is aimed at preventing/reducing disaster in order to save lives from the tsunami accompanying with Nankai great earthquakes expected in several decades from experience that precious lives of twenty thousand and more people were lost by an unexampled great tsunami accompanying with the Great East Japan Earthquake.

In the Great East Japan Earthquake, an unexampled great tsunami accompanying with severe earthquake vibrations such as a seismic intensity of 6 occurred and precious lives of twenty thousand people or more were lost. However, even after that, the tsunami occurs by an outerrise earthquake, and also it should be paid attention to a larger earthquake. In addition, it has been said that the Nankai great earthquake expected to occur over a probability of 70% or more in several decades will cause hundreds of thousands of casualties and also a total amount of damage will exceed 230 trillion Yen.

In this way, with respect to an unavoidable natural disaster, there is no doubt that an infrastructure is maintained, and also the disaster should be reduced and prevented from every aspect. In particular, a time taken from the earthquake to the attack of the great tsunami is extremely short in the Nankai great earthquake. Therefore, it is hard to take measures for the disaster. The tsunami is not simply saying that a water level is high, but also rushes together with debris at 115 km/h on the sea and at 40 km/h on the earth. However, since a distance that the aged may flee by walk is barely at least 500 meters, it is an undeniable fact that a probability to save people will be extremely lowered if the safety is not secured on that spot.

### BACKGROUND ART

JP-A-2016-132449 discloses a tsunami shelter which is made by a user to be hardly sank and burn. Since the great tsunami rushes together with debris, such a configuration cannot endure a large impact of the tsunami. Therefore, it is possible to easily estimate that the shelter is destructed, and there is a concern that the tsunami shelter is not suitable.

JP-A-2016-053297 discloses a tsunami shelter, and JP-A-2015-178769 discloses a shelter system for tsunami. It may be evaluated a little bit about that the tsunami shelter function is provided in a part of a building. However, the idea of the disclosure is basically different from that of the invention.

JP-A-2016-053296 discloses a structure which reduces an impact with respect to debris and is configured to prevent houses from being swept away. However, in such a structure, the shelter may be broken into pieces by the great tsunami, and thus there is a concern that the function of the tsunami shelter cannot be exerted at all.

JP-A-2016-048027 proposes a tsunami shelter for which a person can easily go in and out from the lower portion and which is air-tightened in the upper side. There is a concern that the great tsunami rushes together with the debris, and thus there is a concern that the tsunami and the debris reach up to the upper side of the seal portion. In addition, there is a concern that it cannot exert the function as the tsunami shelter.

JP-A-2016-000935 discloses a tsunami shelter with which the refuge is easily and rapidly performed, a safe space can be formed without closing a water shielding hatch. Similarly to JP-A-2016-048027, there is a concern that the great tsunami rushes together with the debris, and thus the tsunami and the debris reach up to the upper side of a sealing portion to break the tsunami shelter. There is a concern that the tsunami shelter cannot exert the function.

JP-A-2015-137540 discloses a tsunami shelter which is easily manufactured even by an amateur and is not sank even when the tsunami shelter is filled with the water. The tsunami is not simply saying that a water level is high, but also debris rushes at 24 km/h on the sea and at 8 km/h on the earth. Therefore, in such a structure, the shelter may be broken by the debris before floating on the water, and there is a concern that the shelter is not suitable.

JP-A-2015-110351 discloses a tsunami shelter in which people can wait for rescue while drifting at the time of attack of the tsunami. However, as described above, since the tsunami is not simply saying that a water level is high, but also debris rushes at 24 km/h on the sea and at 8 km/h on the earth, such a structure may be broken by the debris before floating on the water, and there is a concern that the shelter is not suitable.

JP-A-2015-063145 discloses a tsunami shelter which can be evaluated a little bit about that people can wait for rescue in the shelter while floating and drifting on the water at the time when the tsunami attacks. However, the idea of the disclosure is basically different from that of the invention.

JP-A-2015-021225 and JP-A-2011-106142 disclose a rectangular steel shell box body having a shape capable of floating according to a water level of the tsunami, and a steel shell box body which is disposed closely to one of the both side surfaces facing the rectangular steel shell box body. As described above, the tsunami is not simply saying that a water level is high, but also debris rushes at 24 km/h on the sea and at 8 km/h on the earth. Therefore, in such a structure, the tsunami shelter may be broken by the debris before floating on the water, and there is a concern that the tsunami shelter is not suitable.

JP-A-2014-104778 provides a tsunami shelter which is suitable even in a case where air tightness is not such a high. However, it is very hard for the physically weak such as an old person to go up to a door of the upper portion. Further, as descried above, the tsunami is not simply saying that a water level is high, but also rushes together with debris at 115 km/h on the sea and at 40 km/h on the earth. Therefore, when the air tightness is not high, there is a concern that the water may come into from the door of the upper portion, and there is a concern that the tsunami shelter is not suitable.

JP-A-2014-020130 provides a tsunami shelter which is evaluated a little bit about that it is strong against an obstacle such as drifting wood and debris even when the shelter is drawn into a muddy stream. However, the idea of the disclosure is basically different from that of the invention.

JP-A-2014-009466 provides a tsunami shelter which is similar to that of JP-A-2016-000935. There is a concern that the great tsunami rushes together with the debris, and thus there is a concern that the tsunami and the debris reach the inner space and break the shelter. In addition, there is a concern that it cannot exert the function as the tsunami shelter.

JP-A-2013-160037 is to provide a tsunami shelter in which the window and an exit are strengthened, which has been a weak point of reinforced concrete. However, there is a problem in that the water level of the tsunami does not fall down in some installation places, and there is dangerousness for a refugee to undergo anoxia.

JP-A-2013-079560 discloses a shelter which is a tsunami shelter facility installed immediately near a place where the people is present, and thus the people can conveniently flee in a short time before the tsunami attacks. However, there is a problem in that the water level of the tsunami does not fall down in some installation places, and there is dangerousness for a refugee to undergo anoxia

JP-A-2013-067952 discloses a tsunami shelter which is evaluated a little bit about that a number of refugees can flee to the shelter at the same time when the tsunami rushes, and also no critical damage is caused in the bodies of the uncontainable refugees without causing any chaos at the time of the refuge. However, the expression that no critical damage is caused in the bodies of the uncontainable refugees is not clear, and the idea of the disclosure is basically different from that of the invention.

JP-A-2013-002188 discloses a tsunami shelter which is for a tsunami damage and can secure a safe shelter for the people from a large water pressure of the tsunami attacking from an unexpectable direction. Similarly to JP-A-2013-160037 and JP-A-2013-079560, there is a problem in that the water level of the tsunami does not fall down in some installation places, and there is dangerousness for a refugee to undergo anoxia.

JP-A-2012-233385 has a problem in that the water level of the tsunami does not fall down in some installation places, and there is dangerousness for a refugee to undergo anoxia similarly to JP-A-2013-160037 and JP-A-2013-079560. JP-A-2006-226099 has also the same problem.

JP-A-2008-074385 provides a tsunami shelter device which suppresses vibration caused when the floating but not flowing tsunami shelter is floating and drifting so that safety is high and many refugees delayed in fleeing can be saved. As can be seen from a video taken when the tsunami accompanying with the Great East Japan Earthquake, it is difficult to prevent the vibration in the presence of the muddy stream of a large tsunami, and there is a concern that the shelter itself is damaged because a countermeasure for preventing the drifting is against a severe tide. This disclosure also has a different basic idea from the invention.

JP-U-3206747 and JP-U-3193067 have a problem in that the water level of the tsunami does not fall down in some installation places, and there is dangerousness for a refugee to undergo anoxia similarly to JP-A-2013-160037, JP-A-2013-079560, and JP-A-2012-233385

JP-U-3181686 provides a rescue box which can move, is mounted in a trailer to be used at any time, and floats when the tsunami attacks for rescue. However, the basic idea is different from the invention.

JP-U-3181620 discloses a tsunami shelter in which a person can easily escape to the outside even when there is debris in the vicinity of an entrance of the shelter, into which the person can easily and rapidly flee even the person is not a healthy person. In addition, the tsunami shelter has a waterproof specification, and thus is buried under the ground. Similarly to JP-A-2013-160037, JP-A-2013-079560, JP-A-2012-233385, JP-U-3206747, and JP-U-3193067, there is a problem in that the water level of the tsunami does not fall down in some installation places, and there is dangerousness for a refugee to undergo anoxia.

JP-U-3177047 discloses a tsunami shelter which can be provided in the vicinity of refugees, contain a certain number of people, and provide a long refuge stay until the tsunami runs away. Similarly to JP-A-2013-160037, JP-A-2013-079560, JP-A-2012-233385, JP-U-3206747, JP-U-3193067, and JP-U-3181620, there is a problem in that the water level of the tsunami does not fall down in some installation places, and there is dangerousness for a refugee to undergo anoxia.

JP-U-3170840 has a problem in that the water level of the tsunami does not fall down in some installation places, and there is dangerousness for a refugee to undergo anoxia similarly to JP-A-2013-160037, JP-A-2013-079560, JP-A-2012-233385, JP-U-3206747, JP-U-3193067, JP-U-3181620, and JP-U-3177047.

JP-A-2015-028408 discloses a device which realizes an atmosphere environment of a hilly area where a number of people can simultaneously take advantage with safety and comfort. However, the device is not possible to be used as a tsunami shelter.

### SUMMARY OF INVENTION

### Technical Problem

An object of the invention is to provide a low-pressure chamber with tsunami shelter function which can endure severe earthquake vibrations even in a huge earthquake such as the Great East Japan Earthquake, endure a severe muddy stream of tsunami even when a great tsunami attacks, endure a strong impact of debris, drift for a long time without being capsized, and keep the life. Further, it is possible to provide a low-pressure chamber with tsunami shelter function which can be used as a low-pressure chamber for maintaining and enhancing health in a normal time.

### Solution to Problem

According to the invention described in claim 1, a movable low-pressure chamber with tsunami shelter function that has strength to endure a negative pressure, includes: a housing that includes an air tight door through which a person can go in and out, wherein the housing includes an air supplying nozzle, an air discharging nozzle, and a housing window in a side surface, the air discharging nozzle is sequentially connected by pipes from a side near the housing to an emergency shutdown valve, a check valve, and an air discharging unit which is used to discharge the air in the housing, the air supplying nozzle is sequentially connected by pipes from a side near the housing to an emergency shutdown valve, a main air filter, a preliminary air filter, and a pressure control valve, the air discharging unit is activated to open and close the pressure control valve while continuously discharging the air in the housing in order to control a pressure in the housing to be a desired pressure curve, and the air tight door includes a door window, and a window glass provided in the housing window and a window glass of the door window provided in the air tight door are provided with a window glass protection unit to protect the window glass.

According to the invention described in claim 2, in the invention described in claim 1, an upper portion of the housing is provided with at least two or more ventilation valves which can be opened or closed from an inside of the housing, and a parietal portion of the housing is provided with an escape hatch which can be opened or closed from the inside of the housing and through which a person can go in and out.

According to the invention described in claim 3, in the invention described in claim 1 or 2, a photovoltaic power generation panel is provided in an outside of the housing, and a secondary battery facility is provided in the housing to charge electricity which is generated by the photovoltaic power generation panel.

According to the invention described in claim 4, in the invention described in any one of claims 1 to 3, a rescue signal transmitting device for transmitting a rescue signal, a flash gun for emitting the rescue signal, and a loud speaker are further provided in the housing.

According to the invention described in claim 5, in the invention described in any one of claims 1 to 4, the air supplying nozzle and the air discharging nozzle are disposed at position to face each other.

### Advantageous Effects of Invention

According to an aspect of a low-pressure chamber with tsunami shelter function of the invention, it is possible to endure severe earthquake vibrations even in a huge earthquake such as the Great East Japan Earthquake, endure a severe muddy stream of tsunami even when a great tsunami attacks, and also endure a strong impact of debris. However, it is possible to wait for rescue while drifting on the water for a long time without being capsized even when a tide level steeply rises such as a tsunami or severe surf waves or drawback waves occur. Therefore, there is a chance to save life. Further, it is possible to provide a low-pressure chamber with tsunami shelter function which can be used as a low-pressure chamber for maintaining and enhancing health in a normal time.

According to another aspect of the low-pressure chamber with tsunami shelter function of the invention, a fresh air can be introduced from the outside by opening a ventilation valve when the tsunami calms down and drifts. Therefore, it is possible to prevent dyspnea and anoxia which are caused when the concentration of a carbon dioxide gas is increased in the housing. In addition, since the people can escape upward the housing when an escape hatch is opened, it is possible to easily rescue the people when a rescue boat and a helicopter arrive.

According to another aspect of the low-pressure chamber with tsunami shelter function of the invention, a lighting device can be turned on even at night during the drifting using the electricity charged in the secondary battery, so that a feeling of insecurity caused by darkness can be alleviated. In addition, if a water heater is used, an instant ramen can be prepared, and also a coffee can be made, so that a feeling of insecurity and loneliness during the drifting can be alleviated.

According to another aspect of the low-pressure chamber with tsunami shelter function of the invention, a rescue signal can be always transmitted even during the drifting due to the tsunami.

According to still another aspect of the low-pressure chamber with tsunami shelter function of the invention, in a normal time, the pressure in the housing can be controlled at a desired pressure curve with a less time lag.

Other objects, features, and advantages of the invention will become clear through the explanation about the following embodiments with reference to the accompanying drawings as follows.

### BRIEF DESCRIPTION OF DRAWINGS

FIG. 1 is a perspective view partially illustrating a front view of an embodiment of the invention.

FIG. 2 is a perspective view partially illustrating a front view of another embodiment of the invention.

FIG. 3 is a cross-sectional view taken along a line I-I of FIG. 1, and a cross-sectional view taken along a line II-II of FIG. 2.

### DESCRIPTION OF EMBODIMENTS

Hereinafter, embodiments of the invention will be described in detail with reference to the accompanying drawings. The same components will be denoted with the same symbols in the drawings.

### EMBODIMENTS

### First Embodiment

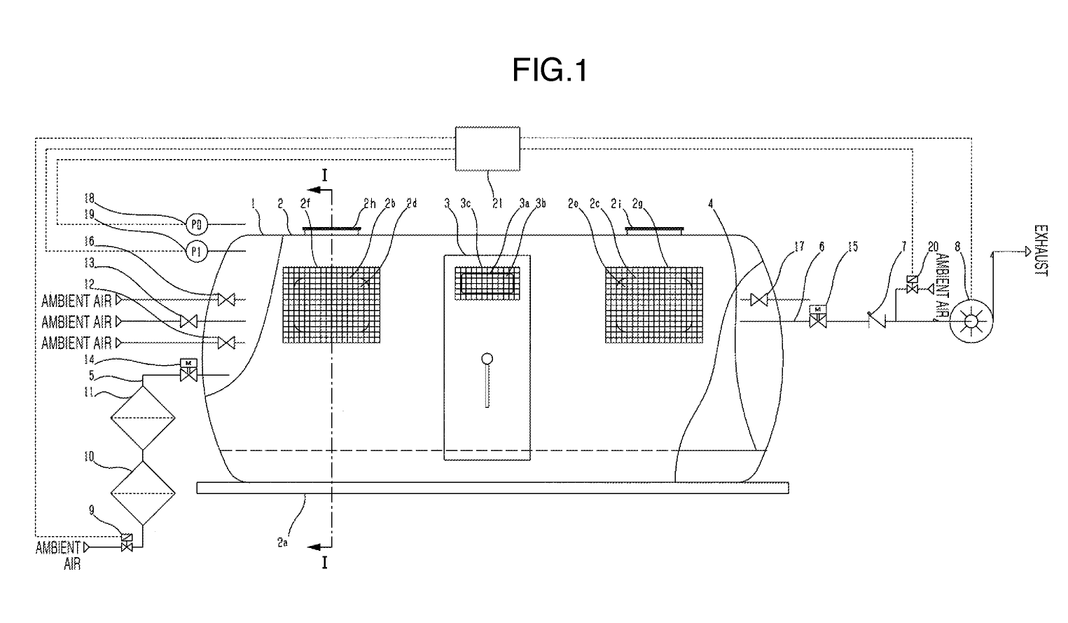

FIG. 1 illustrates a movable low-pressure chamber with tsunami shelter function 1 which has strength to endure a negative pressure and is provided with a housing 2 equipped with an air tight door through which a person can enter and exit. The housing 2 includes an air supplying nozzle 5, an air discharging nozzle 6, and housing windows 2b and 2c in the side surface. The air discharging nozzle 6 is sequentially connected by pipes from a side near the housing 2 to an emergency shutdown valve 15, a check valve 7, and an air discharging unit 8 which is used to discharge the air in the housing 2. The air supplying nozzle 5 is sequentially connected by pipes from a side near the housing 2 to an emergency shutdown valve 14, a main air filter 11, a preliminary air filter 10, and a pressure control valve 9. The air discharging unit 8 is activated to open and close the pressure control valve 9 while continuously discharging the air in the housing 2 in order to control the pressure in the housing 2 to be a desired pressure curve. The air tight door 3 includes a door window 3a, and window glasses 2d and 2e provided in the housing windows 2b and 2c and a window glass 3b of the door window 3a provided in the air tight door 3 are provided with window glass protection units 2f, 2g, and 3c to protect the window glasses 2d, 2e and 3b.

Therefore, it is possible to endure severe earthquake vibrations even in a huge earthquake such as the Great East Japan Earthquake, endure a severe muddy stream of tsunami even when a great tsunami attacks, and also endure a strong impact of debris. However, it is possible to wait for rescue while drifting on the water for a long time without being capsized even when a tide level steeply rises such as a tsunami or severe surf waves or drawback waves occur. Therefore, there is a chance to save life. Further, it is possible to provide the low-pressure chamber with tsunami shelter function 1 which can be used as a low-pressure chamber for maintaining and enhancing health in a normal time. Since the air discharging unit 8 continuously operates in a reduced pressure, there is a need to control the pressure in the low-pressure chamber with tsunami shelter function 1 by opening and closing the pressure control valve 9. Then, the ambient air is supplied into the low-pressure chamber with tsunami shelter function 1 from the pressure control valve 9, so that it is possible to prevent a concentration of a carbon dioxide gas from being increased by the breathing of people in the shelter. Therefore, a lot of people can enter the shelter in a confined space.

Further, the upper portion of the housing 2 is provided with at least two or more ventilation valves 16 and 17 which can be opened or closed from the inside of the housing 2, and the parietal portion of the housing 2 may be provided with escape hatches 2h and 2i which can be opened or closed from the inside of the housing 2 and through which a person can go in and out.

With this configuration, a fresh air can be introduced from the outside by opening the ventilation valves 16 and 17 when the tsunami calms down and drifts. Therefore, it is possible to prevent dyspnea and anoxia which are caused when the concentration of the carbon dioxide gas is increased in the housing 2. In addition, since the people can escape upward the housing 2 when the escape hatches 2h and 2i are opened, it is possible to easily rescue the people when a rescue boat and a helicopter arrive.

In addition, the air supplying nozzle 5 and the air discharging nozzle 6 may be disposed at positions to face each other.

Therefore, in a normal time, the pressure in the housing 2 can be controlled at a desired pressure curve with a less time lag.

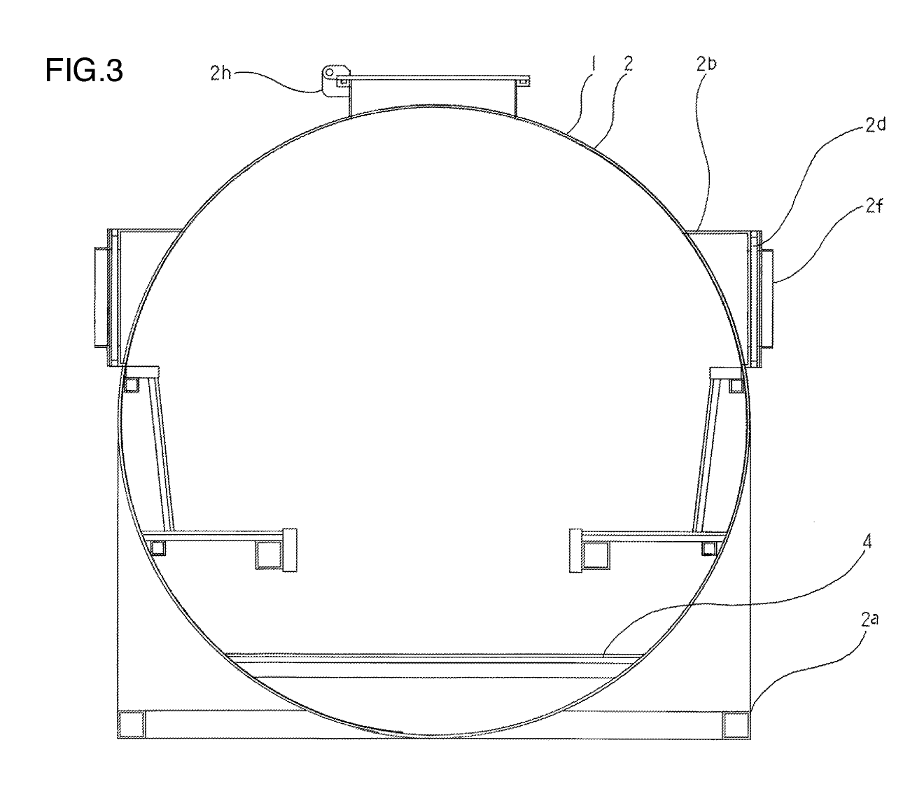

In this embodiment illustrated in FIG. 3, the housing 2 of the low-pressure chamber with tsunami shelter function 1 is made of a steel plate of which the inner diameter is 2300 mm, the length of a straight trunk portion is 3000 mm, and the thickness is 9 mm. Mirror plates at both ends in the straight trunk portion are made as a 10% torispherical head. In the air discharging unit 8, three vacuum pumps KRF25A made by Orion Machinery Co. are used, ADK11-25A made by CKD Co. is used as the pressure control valve 9, a pre-neutrality air filter and a standard HEPA filter made by Nippon Muki Co. are used as the preliminary air filter 10 and the main air filter 11, and the emergency shutdown valve EKE100-10STLBS40 made by KITZ Co. is used as the emergency shutdown valves 14 and 15, but there is no limitation to these products. Any products may be used as long as the same performance is obtained.

Herein, the straight trunk portion indicates a portion which is straight in a cylindrical shape, and the mirror plates are caps for sealing both ends of the straight trunk portion having a cylindrical shape. In addition, a steel plate (a carbon steel plate for general structures) is used as a material of the straight trunk portion in this embodiment, and a stainless steel plate may be used, or other non-ferrous metallic materials or non-metallic materials may be used, and the invention is not limited thereto. The 10% torispherical head is used as the mirror plate in this embodiment, and a semi-ellipsoid mirror plate, a ribbed flat plate, or a conical shape may be used, and the invention is not limited to these shapes as long as the air can be held.

In addition, a 20 mm acrylic material is used as the window glasses 2d, 2e, and 3b, and a steel grating HXB-16075 Made by Kaneso Co. and three woven wire meshes having a wire diameter of 2 mm complying with JIS-G-3555-1964 standard are used in the outer side of a grating as a window glass protection unit 3c, but the invention is not particularly limited thereto. The window glasses 2d, 2e, and 3b may be a transparent plate made of polycarbonate, and other materials may be used.

The housing 2 of the low-pressure chamber with tsunami shelter function 1 of this embodiment has an inner diameter of 2300 mm, a straight trunk portion (a straight cylindrical portion like a tea canister) of 3 m, and an inner volume of 12 m³ or more. The weight of the low-pressure chamber with tsunami shelter function 1 in this case is 3 tons or less, and in a sufficiently floatable state. At the time of the attack of tsunami caused by the Great East Japan Earthquake, warships of the Japan Maritime Self-Defense Force felt the tsunami attack and rearranged to face the coming tsunami because the ships might be overturned or sunk if the ships come into contact with a cross sea. Since the low-pressure chamber with tsunami shelter function 1 of the invention has a shape of a submarine from the beginning, it can also recover the posture without being sunk if the chamber is overturned.

Further, in a case where the tsunami attacks in a state where the pressure of the low-pressure chamber with tsunami shelter function 1 is low, and the chamber enters a stable drift state, an indoor emergency valve 12 and an air valve 20 are slowly opened and the chamber can be decompressed to an atmosphere pressure. Herein, the indoor emergency valve 12 is a valve which is opened by the user to decompress the pressure in the low-pressure chamber with tsunami shelter function 1 to the atmosphere pressure by opening the valve in a case where the low-pressure chamber with tsunami shelter function 1 is disconnected from power or is out of control. The outdoor emergency valve 13 is a valve which is opened by an outsider to decompress the low-pressure chamber to the atmosphere pressure in a case where the low-pressure chamber with tsunami shelter function 1 is disconnected from power or is out of control. Further, the air valve 20 is opened to naturally ventilate the chamber at the time when the low-pressure chamber with tsunami shelter function 1 is drifted by the tsunami. The air valve is closed up in normal time.

### Second Embodiment

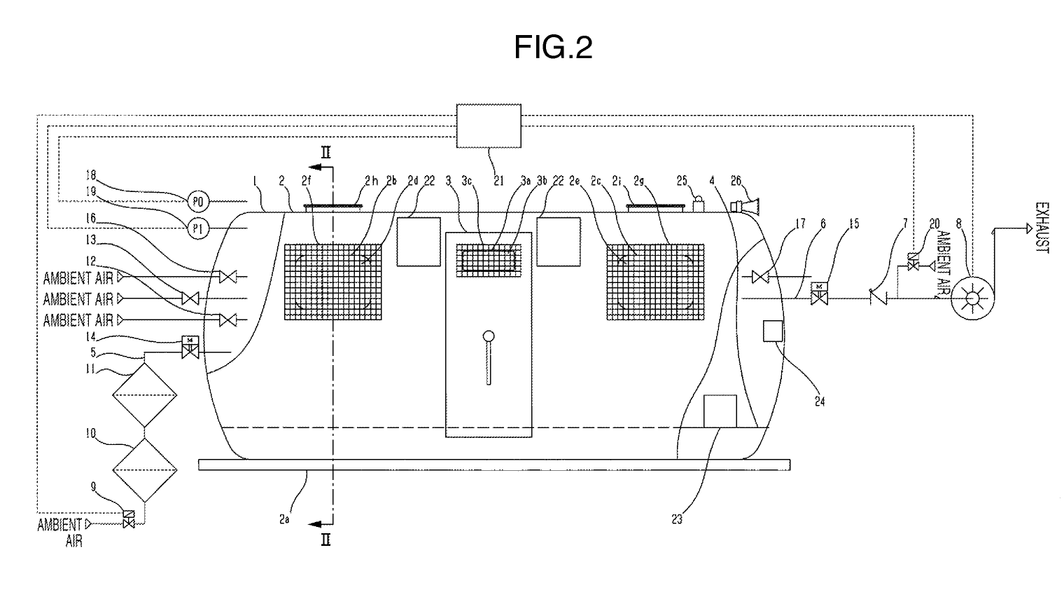

The basic configuration is the same as that of the first embodiment. Therefore, the common configuration will not be described herein. In the outside of the housing 2 illustrated in FIG. 2, a photovoltaic power generation panel 22 is provided, and a secondary battery facility 23 is provided in the housing 2 to charge the electricity generated by the photovoltaic power generation panel 22.

With these configurations, lighting devices can be turned on even at night using the electricity charged in the secondary battery, so that a feeling of insecurity caused by darkness can be alleviated. In addition, if a water heater is used, an instant ramen can be prepared, and also a coffee can be made, so that a feeling of insecurity and loneliness during the drifting can be alleviated.

In addition, a rescue signal transmitting device 24 for transmitting a rescue signal, a flash gun 25 for emitting the rescue signal, and a loud speaker 26 may be provided in the housing 2.

With these configurations, the rescue signal can be always transmitted even during the drifting due to the tsunami.

The above description has been given about embodiments, but the invention is not limited thereto. A person skilled in the art can know that various changes and modifications may be made within a range not departing from the spirit of the invention and the accompanying claims.

### INDUSTRIAL APPLICABILITY

If a low-pressure chamber with tsunami shelter function of the invention is disposed in lots of seashores where there are a lot of private houses, and is used as a health maintaining and enhancing facility for the aged, and rapidly changed to the tsunami shelter at the time of earthquake. Therefore, since the people are familiar with the shelter, an evacuation behavior can also be significantly smoothened. When 1,000 low-pressure shelters, each of which has a capacity of 40 people, are installed, precious human lives of 40,000 can be saved.

### REFERENCE SIGNS LIST

1 low-pressure chamber with tsunami shelter function
2 housing
2a stand
2b housing window
2c housing window
2d window glass
2e window glass
2f window glass protection unit
2g window glass protection unit
2h escape hatch
2i escape hatch
3 door
3a door window
3b window glass
3c window glass protection unit
4 table
5 air supplying nozzle
6 air discharging nozzle
7 check valve
8 air discharging unit
9 pressure control valve
10 preliminary air filter
11 main air filter
12 indoor emergency valve
13 outdoor emergency valve
14 emergency shutdown valve
15 emergency shutdown valve
16 ventilation valve
17 ventilation valve
18 atmosphere pressure sensor
19 indoor pressure sensor
20 air valve
21 low-pressure chamber control device
22 photovoltaic power generation panel
23 secondary battery facility
24 rescue signal transmitting device
25 flash gun
26 loud speaker

1-5. (canceled)

6. A movable low-pressure chamber with tsunami shelter function that has strength to endure a negative pressure, comprising:
a housing that includes an air tight door through which a person can go in and out,
wherein the housing includes an air supplying nozzle, an air discharging nozzle, and a housing window in a side surface,
the air discharging nozzle is sequentially connected by pipes from a side near the housing to an emergency shutdown valve, a check valve, and an air discharging unit which is used to discharge the air in the housing,
the air supplying nozzle is sequentially connected by pipes from a side near the housing to an emergency shutdown valve, a main air filter, a preliminary air filter, and a pressure control valve,
the air discharging unit is activated to open and close the pressure control valve while continuously discharging the air in the housing in order to control a pressure in the housing to be a desired pressure curve, and
the air tight door includes a door window, and a window glass provided in the housing window and a window glass of the door window provided in the air tight door are provided with a window glass protection unit to protect the window glass.

7. The low-pressure chamber with tsunami shelter function according to claim 6,
wherein an upper portion of the housing is provided with at least two or more ventilation valves which can be opened or closed from an inside of the housing, and a parietal portion of the housing is provided with an escape hatch which can be opened or closed from the inside of the housing and through which a person can go in and out.

8. The low-pressure chamber with tsunami shelter function according to claim 6,
wherein a photovoltaic power generation panel is provided in an outside of the housing, and a secondary battery facility is provided in the housing to charge electricity which is generated by the photovoltaic power generation panel.

9. The low-pressure chamber with tsunami shelter function according to claim 7,
wherein a photovoltaic power generation panel is provided in an outside of the housing, and a secondary battery facility is provided in the housing to charge electricity which is generated by the photovoltaic power generation panel.

10. The low-pressure chamber with tsunami shelter function according to claim 6,
wherein a rescue signal transmitting device for transmitting a rescue signal, a flash gun for emitting the rescue signal, and a loud speaker are provided in the housing.

11. The low-pressure chamber with tsunami shelter function according to claim 7,
wherein a rescue signal transmitting device for transmitting a rescue signal, a flash gun for emitting the rescue signal, and a loud speaker are provided in the housing.

12. The low-pressure chamber with tsunami shelter function according to claim 8,
wherein a rescue signal transmitting device for transmitting a rescue signal, a flash gun for emitting the rescue signal, and a loud speaker are provided in the housing.

13. The low-pressure chamber with tsunami shelter function according to claim 9,
wherein a rescue signal transmitting device for transmitting a rescue signal, a flash gun for emitting the rescue signal, and a loud speaker are provided in the housing.

14. The low-pressure chamber with tsunami shelter function according to claim 6,
wherein the air supplying nozzle and the air discharging nozzle are disposed at position to face each other.

15. The low-pressure chamber with tsunami shelter function according to claim 7,
wherein the air supplying nozzle and the air discharging nozzle are disposed at position to face each other.

16. The low-pressure chamber with tsunami shelter function according to claim 8,
wherein the air supplying nozzle and the air discharging nozzle are disposed at position to face each other.

17. The low-pressure chamber with tsunami shelter function according to claim 9,
wherein the air supplying nozzle and the air discharging nozzle are disposed at position to face each other.

18. The low-pressure chamber with tsunami shelter function according to claim 10,
wherein the air supplying nozzle and the air discharging nozzle are disposed at position to face each other.

19. The low-pressure chamber with tsunami shelter function according to claim 11,
wherein the air supplying nozzle and the air discharging nozzle are disposed at position to face each other.

20. The low-pressure chamber with tsunami shelter function according to claim 12,
wherein the air supplying nozzle and the air discharging nozzle are disposed at position to face each other.

21. The low-pressure chamber with tsunami shelter function according to claim 13,
wherein the air supplying nozzle and the air discharging nozzle are disposed at position to face each other.
